(19) United States
(12) Patent Application Publication
(10) Pub. No.: US 2011/0211937 A1
(43) Pub. Date: Sep. 1, 2011

(54) MANIPULATOR

(75) Inventor: Josef Weinberger, Rohrdorf (DE)

(73) Assignee: ESMO AG, Rosenheim (DE)

(21) Appl. No.: 13/060,992

(22) PCT Filed: Aug. 20, 2009
(86) PCT No.: PCT/EP09/06050

§ 371 Date: May 23, 2011

(30) Foreign Application Priority Data
Aug. 28, 2008 (DE) 10 2008 044 756.0

(51) Int. Cl. B25J 9/00; B66D 1/00; B66D 1/36; B66D 1/12; B66D 1/14; B66D 1/08; B25J 11/00

(52) U.S. Cl. 414/590; 254/364; 254/334; 254/342; 254/278; 254/362; 254/360; 254/361

(57) ABSTRACT

A manipulator for a load has a stand, an accommodation connected to the stand (2, 8) for the load, wherein the accommodation allows movement of the load with respect to the stand with respect to at least a first axis, a drive having a rope pull or a chain or belt drive which supports the movement of the load along the first axis, and an elasticity means acting along the first axis. The elasticity means has a frame translationally displaceable along the first axis with respect to the stand and elastically retained which supports a guiding element of the drive.

### CROSS-REFERENCE TO RELATED APPLICATIONS

This application is the US National Stage of International Application No. PCT/EP2009/006050, having international filing date 20 Aug. 2009, which designated the United States of America and which was published under PCT Article 21 (2) as Publication No. WO 2010/022892 A2 on March 2010, and which claims priority to German Application No. 10 2008 044 756.0, filed 28 Aug. 2008, the disclosures of which are incorporated herein by reference in their entireties.

### BACKGROUND

1. Field

The invention relates to a manipulator for a load.

2. Brief Description of Related Developments

Manipulators serve to move heavy loads. A field of use is moving heavy test heads for integrated circuits, for example CPUs. Due to manufacture, here, there is regularly interest in moving test heads towards ICs. Due to complex circuit technology, the test heads in turn can be very heavy. In the meantime, weights above 500 kg are to be considered normal. The use of test heads with weights above 1000 kg is also to be expected.

In particular in movements of test heads for integrated circuits, there are the following requirements:

the movement has to be free from backlash, since the position tolerances of the movement are very low;

the test heads and therefore also the manipulators often are used in a clean room. Since area and volume in the clean room are extraordinarily expensive, smallness of the manipulators is desired;

since clean rooms require complicated air guides, the floors thereof are often placed on stilts and therefore have a limited area load of for example 500 kg/m². If a manipulator together with the test head is to be installed as intended, in case of a total weight of for example 1 t, an area of 2 m² would already have to be provided which is opposed to the previously mentioned demand for smallness;

the test head is to be able to be moved by a user. This requires low-friction supports on rotation axes and translation axes and rotation axis guides through the respective center of gravity positions. Concerning the movement against the gravity (vertical), supporting mechanisms are necessary.

A known supporting mechanism is the provision of counterweights in a vertical rope pull guide of the test head. It is a disadvantage that the same high weight as the test head already has, is once again to be provided in the counterweight. Thereby, the total weight and accordingly the area requirement increases which is undesirable especially in expensive clean rooms. The mass inertia and thereby problems in terms of control also continuously increase.

A further supporting mechanism is to provide supporting forces to those of a user by a technical drive (electric motor, hydraulics, pneumatics). However, therein, the user direction is still desired, since thereby, positioning and adjusting the load to be moved (test head) in desired flexibility and accuracy can be most simply accomplished. This results in the fact that the supporting force finally is lower than the sum of weight force and static friction force such that the drive alone does not effect the movement, but optionally together with the additional force of the operator is able to cause the vertical movement of the test head or generally of the load.

However, the disadvantage of technical drive systems with respect to weights is that possibly the drive system implicitly provides drive force such that undesired operational states can occur. For example, it is conceivable that a test head inadvertently is placed on the foot of an operator and the drive performs this with downward force such that contusions can occur. Another example is the docking of the test had to the means retaining the chip to be tested. Here, mechanical contact is desired. Comparatively high contact forces are also to be overcome in order to suitably press spring-loaded contact pins. Nevertheless, the guidance has to be such that excessively high forces or forces at the wrong time or at the wrong place are not applied.

The contact between test head on the one hand and test accommodation of the chip to be measured on the other hand occurs in the manner that the coarse approach is effected by the operator. Herein, the manipulator is used as intended. It allows pivoting the test head about one, preferably two, further preferably three rotation axes, and it also allows the translational movement thereof in two or three spatial axes.

Rotary movements generally are not a problem, because upon rotation about a vertical axis, lifting work does not have to be performed, and the load is retained upon rotation about horizontal axes such that the rotation axes extend through the center of gravity of the load such that lifting work does not have to be performed also in this respect. Translations along horizontal spatial directions (in this description x and y direction) also require low forces, since here too only the low friction force has to be overcome.

However, in translations in vertical direction, lifting work has to be performed or the high weight has to be retained in the downward movement. For this, technical drives can be provided, for example electric motors. However, then, the problem can occur that for example upon maloperations by the user, contacts already arise before the load is in the desired position such that the drive possibly still pushes when this should no longer be the case. Destruction of the load or of a coupling site of the load and/or injuries can be the consequence.

Insofar as the operator correctly moves the load, in testing chips, the test head (tester) is manually taken to the correct angular position and the correct spatial position until it is few centimeters apart from the desired test position. Often, this operator-adjusted position is for example defined by mechanical stops. Starting from this defined intermediate position, then, a docking means takes over the so-called “docking”, thus taking the test head from the intermediate position to the final measurement position. At this point, it is desired that technical systems do not operate against each other, thus that in particular the manipulator does not apply vertically undesired forces in addition to those of the docking means.

DE 10 2004 018 474 describes a manipulator shown in FIG. 4 for a load 1. It has a stand 8, a accommodation 3-5 connected to the stand for the load, wherein the accommodation allows a movement of the load with respect to the stand with respect to at least a first axis z, and a drive 14-16 supporting the movement of the load along the first axis. In addition, an elasticity means 11-13 is provided which causes elasticity in the drive train along the first axis. The elasticity means has a mechanic-elastic element 11 which is in balance of forces in the drive train and allows movements along the first axis in both directions. The drive has a rope pull 16-18, wherein the elasticity means elastically supports the rope drum 16 of the rope pull such that it is elastically displaceable along the first axis in accordance with the desired elasticity. The rope drum is in a chassis 12 which is spring-supported mounted pivotably about an axle 13. Thus, the rope drum can a rotary rotational movement with a movement component in the direction of the first axis.

It is a disadvantage of this construction that the pivotable chassis has a high space requirement, if it is to provide the desired elasticity within a freedom of movement not too small, for instance in order to be able to beneficially design sensor technology.

Further relevant prior art is EP 87100158.2, DE 27 42 163, DE 10 2004 026031 and U.S. Pat. No. 6,766,996.

### SUMMARY

As described herein, the exemplary embodiments overcome one or more of the above or other disadvantages known in the art. In one embodiment, a driven manipulator has elasticity in the drive train and is constructed in space-saving manner despite a larger spring travel.

In one embodiment, a manipulator for a load has a stand, a accommodation connected to the stand for the load, wherein the accommodation allows movement of the load with respect to the stand with respect to at least a first axis, and a drive supporting the movement of the load along the first axis. In addition, an elasticity means is provided which causes elasticity in the drive train along the first axis. It has a translationally displaceable, elastically supported frame, to which a guiding element of the drive is attached.

The elasticity means usually moves only slightly along the possible degree of freedom (preferably vertically) which would be caused by dynamic acceleration forces, because the elastic support is statically balanced. However, upon collisions, the drive causes compression of the elasticity means rather than guiding the transported load rigidly against the obstacle, such that possible collisions have less disastrous up to no detrimental consequences. Systematically, (desired) “collisions” are effected during the docking operation of a transported test head. Here, the elasticity means causes certain system softness which is able to compensate for inaccuracies in the alignment.

A switch can be provided which is operable by the translation of the frame. The drive can have an electric motor which is switchable directly by the switch or indirectly via a control.

### BRIEF DESCRIPTION OF THE DRAWINGS

Below, with reference to the drawings, individual embodiments are described. There show:

FIG. 1 a schematic side view of a manipulator,

FIG. 2 a detail of the manipulator in side view,

FIG. 3 the detail of FIG. 2 from above, and

FIG. 4 a known manipulator.

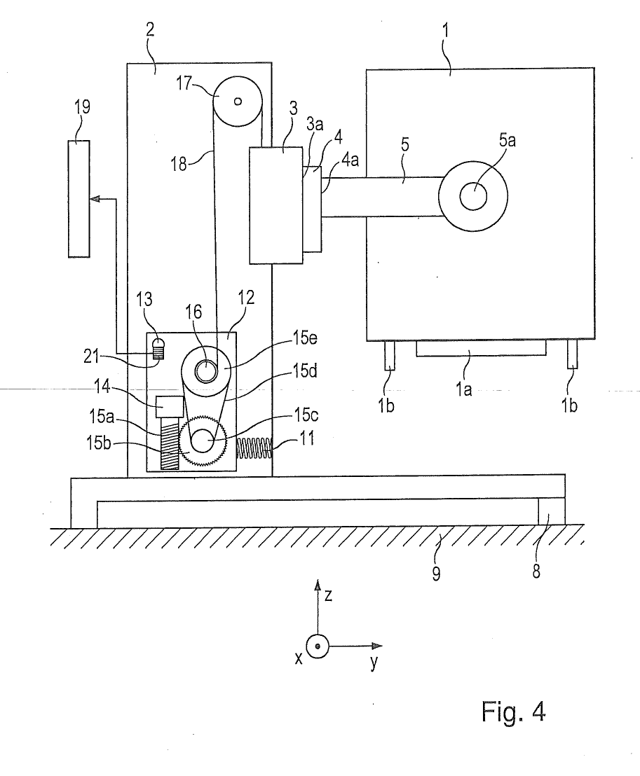

### DETAILED DESCRIPTION OF THE DISCLOSED EMBODIMENTS

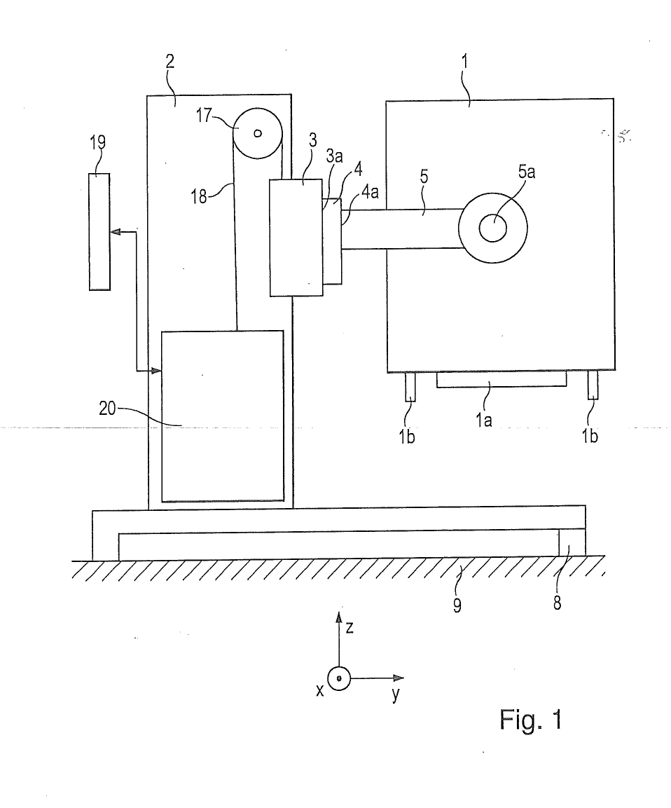

FIG. 1 shows in a schematic side view a manipulator. A stand 8 of suitable size stands on the floor 9. It has a tower 2, along which a carriage 3 is movable in a first axis (here vertically). The tower 2 can be movable in the two horizontal coordinates. On the bottom right in FIG. 1, a coordinate system is indicated. The x coordinate points out of the drawing layer, y to the right and z to the top in the drawing layer. Thus, the carriage 3 is movable along the z axis.

1 denotes the load which is to be movable and pivotable with the manipulator. 1a denotes the contact means, by which the test head 1 can electrically contact the structure to be tested. 1b denotes mechanic guides or centering devices. An intermediate element 4 engages the carriage 3. Between carriage 3 and intermediate element 4, a joint 3a can be provided which allows a rotation about a vertical rotation axis (z axis). An arm 5 protrudes from the intermediate element 4. Between the two, a joint 4a can be provided which allows rotation about the y axis. The arm 5 finally retains the load 1 by means of a joint 5a which allows rotation about the x axis. A joint with vertical rotation axis (z axis) can also be provided.

Furthermore a drive 17-20 is provided which supports the movement of the load along the first axis (z axis in the shown embodiment). The drive can be attached to the fixed portion of the stand 8 or to the tower 2 (already translationally, preferably horizontally movable).

The carriage 3 is guided in not shown rails on the tower 2 and is vertically displaceable. It is pulled upwards or lowered downwards by the drive 17-20. In the shown embodiment, the drive has a rope pull with in particular a rope or belt or chain 18. On the top, the rope 18 extends around a deflection pulley 17 and then downwards to a mechanism 20 yet to be described with an elasticity means.

19 denotes a control which in particular controls or regulates the operation of a motor 25. Sensor technology can be present, for example position sensor technology. There can also be provided input possibilities and intervention possibilities for an operator—not shown.

An elasticity means is provided in the drive train which causes that the introduced driving force is not rigidly coupled to the load to be moved, but that ultimately elasticity prevails between load and power source. In the static state, this elasticity means is balanced and will be designed such that vibrations will not occur even with dynamic actions. Optionally, an attenuator can be provided.

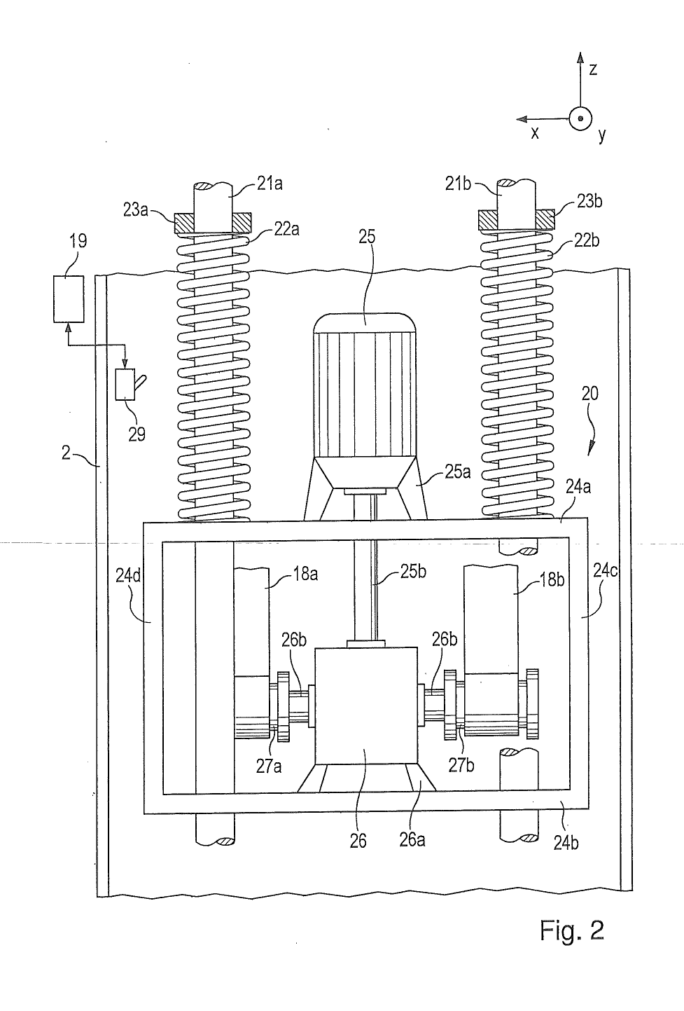

In FIG. 1, a portion of the drive as well as the elasticity means is identified as a “black box 20”. In FIG. 2, an embodiment of the same is represented. In the shown embodiment of FIG. 2, the drive 17-20 and the elasticity means are in the tower 8 of the stand and thus can be translationally, preferably horizontally (x and/or y direction) moved with the tower and the load with respect to the fixed portion of the stand 2. FIG. 2 shows a view opposite to the y direction of FIG. 1.

The drive supports the movement of the load in the vertical direction (z direction). In the shown embodiment, it has a belt drive, in which one or two belts 18a, 18b can be wound or unwound to or from a drum 27a, 27b. The carriage 3 is pulled upwards or guided downwards with these belts 18. The winding or unwinding of the belt 18 can be effected via a gearbox 26 and a motor 25. The belt is guided along a certain path which vertically extends in the tower 8 at least in regions. The belt is guided over guiding elements which e.g. can have one or more deflection pulleys 17 shown in FIG. 1 or the drum 27 shown in FIG. 2. At least one guiding element is elastically supported. Preferably, the drum 27 is elastically supported. The elastic support is effected in the manner that the guiding element 27 is attached to a frame which is elastically supported with respect to the stand 2 or the tower 8. In FIG. 2, the attachment of the drums to the frame is effected via the gearbox 26 which is attached to the frame portion 24b via a gearbox flange 26a. Driven shafts 26a and 26b drive the drums 27a and 27b.

The frame 24 or its individual portions 24a-24d are translationally displaceable. Preferably, they are displaceable in the longitudinal direction of the tower, thus in vertical direction (z direction). The motor 25 can also be attached to the frame 24 or to a frame portion. The motor is attached to the frame portion 24a via a motor flange 25a. The motor shaft 25b is the drive shaft of the gearbox 26.

In a not shown embodiment, motor 25 and gearbox 26 can be fixed with respect to the stand 2 or tower 8, wherein only one deflection pulley is then translationally displaceable. Motor 25 and gearbox 26 can be spaced from each other along the first direction (z direction).

The frame 24 can be guided by one or more longitudinal guides 21a, 21b. The guides can extend along the displacement direction of the frame, thus preferably vertically. In the shown embodiment, comparatively solid rods are shown as guides 21.

The elasticity can be caused in that one or more elastic elements 23a, 23b, preferably springs, in particular helical springs, counteract the weight force of the load. The weight force also acts on the frame 24 via the guiding element 27 retained by the frame (drum or deflection pulley) and would pull it in the direction of the rope/chain/belt 18, if it is freely movable, thus vertically upwards in the shown embodiment. Elastic elements resist it. In the embodiment of FIG. 2, two compression springs 22a, 22b are shown which have their respectively two abutments on the frame 24 on the one hand and on a fixed point 23a, 23b of the stand 2 or of the tower 8 on the other hand. The tower-side fixed point 23 is only schematically indicated in FIG. 2. Here, they are suitable stable abutments.

Preferably, the springs encompass the guides 21 and thus are concentric with them.

The fixed points 23a, 23b can be adjustable to be able to adjust the spring bias and adapt it to different loads. They can be adjustably settable along the first direction.

The compression springs can be comparatively long. Their length can be a considerable portion of the tower height, for instance at least 25% of the tower height. In this manner, a relatively long spring travel results such that a relatively large spring travel or translation path can arise upon response.

The frame 24 can displace either because an undesired operational state has occurred, for instance because the load to be moved has been moved against an obstacle, or because acceleration operations occur. The dimensioning of springs, drive and sensor technology is effected such that vibrations are avoided and will not result in misdetections, respectively.

The frame can have one or more plates 24a, 24b. If several are provided, they can be spaced in the direction of the first direction (z direction) and connected to each other, for instance via connection components 24c, 24d. The plates 24a, 24b can substantially horizontally extend or extend orthogonally to the first direction. If several plates are provided, the motor 25 can be flanged to one 24a of the plates and the gearbox 26 can be flanged to another one 24b of the plates as shown in FIG. 2. However, only one plate 24 can also be provided. Motor and gearbox can then be flanged to opposing sides of the one plate.

The provision of two plates has the advantage that cants of the frame with respect to its guides are avoided. For this purpose, however, instead of a second plate, only a further guiding element spaced in the direction of the guides can also be provided which again abuts the guide, just to avoid cants.

The embodiment of FIG. 2 shows compression springs supporting against the top which press the frame 24 downwards against the pulling force acting upwards.

However, tension springs are also possible which can engage the other side (below) of the frame to pull it downwards against the acting force.

With respect to the known manipulator construction, the described construction has the advantage that a larger spring travel can be constructed in a space which is present anyway, namely the volume of the tower extending upwards. With the torsionally elastic support as it is described in the known embodiment, in contrast, lateral pivoting of the chassis supporting the rope drum was inevitable such that additional space had to be provided for allowing this movement, and the air space located above the chassis in the tower was not utilized. Moreover, the available spring travel was comparatively short in the known embodiment such that difficulties arose with respect to the detection.

A switch 29 is provided which is operable by the moving frame 24. It is a digital on/off switch connected to the control 19 in turn controlled like the manipulator component, in particular also the motor 25. The switch 29 can be an off-switch, upon the operation of which the drive is switched off or even driven into the other direction. The comparatively long spring travel allows providing a switch 29. With shorter spring travels, as they were in particular present in the known embodiment, this is difficult because exactly due to the short travels, a switch 29 cannot be sufficiently finely adjusted. The switch 29 can be displaceable along the displacement path of the frame 24 such that it can detect different positions of the frame according to its adjustment.

Several switches 29 can be provided, preferably in different positions along the displacement path of the frame 24. Additionally or instead, a (not shown) analog path sensor can also be provided which senses the path or the position of the frame 24 along its possible displacement path (first direction, z direction), optionally converts it in digital and provides it to the control 19 for appropriate measures.

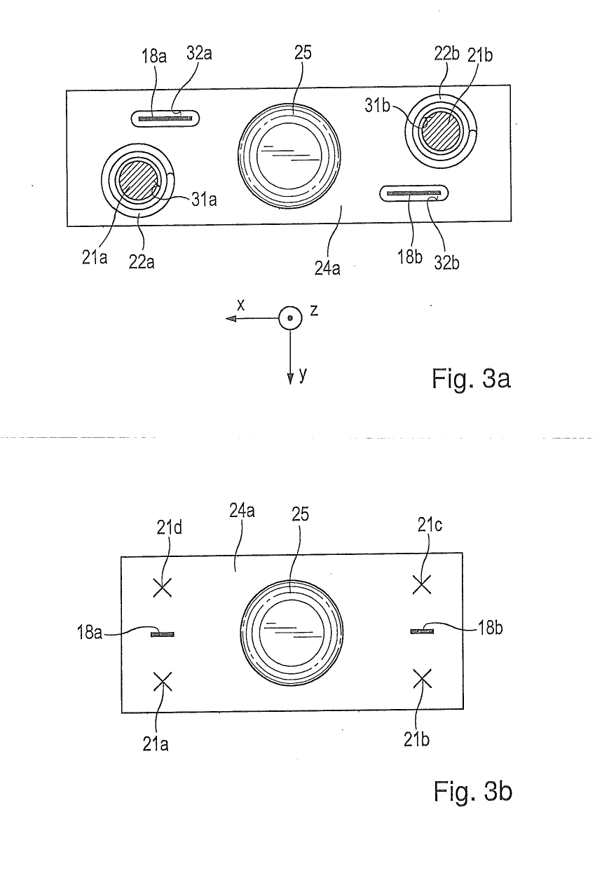

FIGS. 3a and 3b show more or less schematically a plan view of the frame 24. The FIGS. 3a and 3b show a view opposite to the z direction of FIG. 1. From above, in FIG. 3, the motor 25 can be seen which can be an electric motor or another motor (hydraulic, pneumatic). The plate 24a can have several recesses, for instance holes 31a, 31b, for the guides 21a, 21b and holes or slits 32a, 32b for ropes, chains or belts 18 of the drive.

FIG. 3a shows an embodiment, in which on the left and right, the front/rear relation of guide and belt is interchanged with each other in order to prevent asymmetric force introduction as far as possible. However, according to the construction, the distribution can also be equal (thus that e.g. recesses 32b in FIG. 3 would also be above the recess 31b). Furthermore, it is conceivable to guide the belts, ropes or chains 18 completely outside of the plate 24a.

In the embodiment of FIG. 3b, guides 21 are only schematically indicated by crosses and dashes in their position with respect to the plate 24a. More than two guides 21 can be provided, for instance four guides which are approximately disposed in the corner regions of the plate 24a. Between each one pair (21a and 21d or 21d and 21c) of the guides, each one rope, belt or chain 18a, 18b can be located.

The frame 24 or a plate 24a, 24b of the same can occupy a substantial portion of the cross-sectional area of the tower 2, for instance at least 30%. In this manner, they can be relatively largely constructed such that a stable construction can be built for the high forces to be absorbed, without therefore the tower having to be enlarged. At the same time, an adjustably large spring travel results which allows a comparatively exact adjustment of the switch 29. The detection accuracy is thereby improved.

The controller 19 can be non-linear (threshold characteristic, hysteresis characteristic). The controller can for example only output signals like forward/rearward/zero to the motor in the normal operation, and can in turn have a force or path feedback from the manipulator 1-18.

Below, optionally, some technical data:

Rated load>500 kg, preferably >1000 kg
Spring constant>5 kN/m, preferably >10 kN/m,
<100 kN/m, preferably <50 kN/m
   Docking path>1 cm, preferably >2 cm,
<10 cm
   Max. docking force>100 N, preferably >200 N
<5000 N, preferably <2000 N

1. A manipulator for a load, comprising:
a stand,
an accommodation connected to the stand for the load, wherein the accommodation allows movement of the load with respect to the stand with respect to at least a first axis,
a drive having a rope pull or a chain or belt drive which supports the movement of the load along the first axis, and
an elasticity means acting along the first axis,
wherein the elasticity means has a frame translationally displaceable along the first axis with respect to the stand and elastically retained, which supports a guiding element of the drive.

2. The manipulator according to claim 1, wherein the guiding element comprises a drum or a deflection pulley.

3. The manipulator according to claim 1 wherein the drive has a motor attached to the stand or to the frame.

4. The manipulator according to claim 1, further comprising one, two or more guides extending along the first axis, along which the frame is guided.

5. The manipulator according to claim 1, wherein the frame has two plates connected to each other and spaced along the first axis which both can be guided by guides extending along the first axis.

6. The manipulator according to claim 5, wherein the drive is attached to one of the plates and a gearbox is attached to the other one of the plates.

7. The manipulator according to claim 1, further comprising two or more parallel rope pulls or chain or belt drives.

8. The manipulator according to claim 7, further comprising four guides, wherein the rope or belt or chain extends between each two of the guides.

9. The manipulator according to claim 1, wherein a switch operable by the frame on the possible translation path thereof.

10. The manipulator according to claim 1, further comprising a force or path sensor and a control that receives a sensor signal and controls or regulates the drive.

11. The manipulator according to claim 1, wherein the drive has an electric motor.

12. The manipulator claim 1, wherein the drive has a hydraulic and/or pneumatic means.

13. The manipulator according to claim 1, wherein the first axis is a vertical axis.

14. The manipulator according to claim 1, wherein the receptacle accommodation allows movement of the load with respect to the stand with respect to several axes, in particular several translation and/or rotation axes.
